(19) United States
(12) Patent Application Publication
(10) Pub. No.: US 2017/0000103 A1
(43) Pub. Date: Jan. 5, 2017

(54) Agricultural Sprayer and Agricultural Sprayer Arm in Composite Construction

(71) Applicant: CarboFibretec GmbH, Friedrichshafen (DE)

(72) Inventors: Erhard Wissler, Bissingen/Teck (DE); Thomas Leschik, Meckenbeuren (DE); Olaf Helms, Meitingen (DE)

(21) Appl. No.: 15/200,354

(22) Filed: Jul. 1, 2016

(30) Foreign Application Priority Data
Jul. 2, 2015 (DE) 102015110696.5

(51) Int. Cl. A01M 7/00; A01C 23/00

(52) U.S. Cl. CPC A01M 7/0075; A01C 23/008

(57) ABSTRACT

The invention relates to an agricultural sprayer arm to attach a conduit spreading a good, with multiple foldable segments articulately attached to each other, the shape of at least one segment of which is determined by longitudinal beams mainly loaded by traction and diagonal braces connected thereto and mainly loaded by pressure and/or torsion, wherein the longitudinal beams are made of fiber reinforced material and the diagonal braces are made of a light alloy. The invention also relates to an agricultural sprayer comprising one such agricultural sprayer arm or two such agricultural sprayer arms.

The invention relates to an agricultural sprayer arm to attach a conduit which is prepared to deploy/spread a good, wherein such spreadable good can be pesticide, fertilizer or seed, with multiple foldable segments articulately attached to each other, the shape of at least one segment of which is determined by longitudinal beams strained mainly by tension and diagonal braces connected therewith and mainly strained by pressure and/or torsion.

Such agricultural sprayer arms are already known from the prior art, and comprise generally light metal components. In general, two agricultural sprayer arms protruding on both sides of the vehicle are used in a land vehicle, such as a tractive unit or a self-propelled vehicle. The agricultural sprayer arms can be folded in the vehicle, such that the overall width of the vehicle is sufficiently small so as to drive on normal streets.

It is the object of the present invention to improve the agricultural sprayer arms, such that the good to be spread can be spread more accurately. A reduction of a swing should be achieved. In addition, the length of the agricultural sprayer arms should also be increased, such that a larger area can be covered by the agricultural sprayer arm. In particular, the weight of the agricultural sprayer arms should be significantly reduced.

The object is solved in an agricultural sprayer arm according to the principle of the present invention by forming the longitudinal beams from fiber-reinforced material and forming the diagonal braces from a light metal alloy.

Therefore, an almost ideal construction for holding the agricultural sprayer conduits is provided. In particular, a pesticide conduit is thereto attachable and the segments are themselves foldable by themselves, such that the agricultural sprayer arm is foldable. A special hybrid construction presented here represents an optimal compromise between lightweight construction and cost efficiency.

Fiber-reinforced materials and light weight construction materials are thereby combined in a particularly clever way. Such an agricultural sprayer arm can be produced by fabricating the longitudinal beams which mainly receive traction forces, by configuring them to be made of/to include carbon fibers or another suitable fiber-reinforced material. The diagonal braces or alternative shear panels, which mainly have to receive pressure forces or torsion forces, are made of metallic lightweight material, in particular, aluminum alloys or other lightweight materials or in composite construction, for example, aluminum fiber-reinforced composite components.

The assembling of the individual components can be designed thereby in a releasable manner, for example by using screws or rivets, or also in a non-releasable manner. In the non-releasable variations, adhesive solutions, laser welding or combination of adhering together with rivets or screws have proved themselves.

These solutions represent contrary to their “pure” construction only of fiber-reinforced materials or only of metal materials, a more material-specific and more sensible construction, such that the characteristics of the individual materials in this embodiment are better utilized. Especially in countries with high import tariffs or large distances, this construction has an enormous advantage, because aluminum assemblies/light metal assemblies are more easily procured locally.

Advantageous embodiments are claimed in the dependent claims and described hereafter in more detail.

Thus, it is advantageous, if the segment comprises a bottom to which some (or all) longitudinal beams and/or some (or all) diagonal braces are connected and which preferably has perforations in approximately predetermined intervals, for example, circular through holes, wherein a fluid conduit or a bulk good conduit is attached/attachable to the bottom, such that some good such as a pesticide, a fertilizer or a seed is spreadable through the perforations. In such a design, a compact construction can be realized.

For the mounting, it is advantageous, if the longitudinal beams and/or the diagonal braces are designed hollowly, for example, in the manner of open or closed hollow cylinders. The total weight is thereby also reduced effectively.

Further, it is advantageous, if the agricultural sprayer arm comprises a distal segment consisting of one or multiple fiber-reinforced material surface components. That agricultural sprayer arm between (precisely) two joints is understood as a segment. Longitudinal beams and/or diagonal braces are then dispensable and a component, having a closed cross section, which is substantially made only of fiber-reinforced material, is usable. The stability is thereby increased, the weight is reduced, and the rigidity is improved. In particular, the weight is reduced at that position in which it has the largest leverage effect.

It is expedient, if the distal segment comprises three surface components, which are formed in one piece or are connected with each other in the manner of form fit, force fit and/or material fit. Just a three-dimensional symmetrical design, preferably an isosceles or equilateral design, is technically optimal for manufacture and has particularly good stability values.

In order to allow an efficient spreading/deployment of commodities/goods/grit, it is advantageous, if the fluid and/or bulk good conduit is attached to the inner side or to the outer side of a surface component oriented substantially horizontally in the operating position. A simple cleaning and repairing can be then carried out.

It is also advantageous, if the two segments are connected, for example, in the area of the joints via at least one actor causing a flapping action/folding-in in the operation case/transport mode, such as an hydraulic cylinder, a pneumatic cylinder or an electric motor. A desired folding after operating can then be caused easily but purposefully by the driver of the vehicle.

If the actor bridges a joint between two segments, a purposeful kinematics is applicable.

Further, it is advantageous, if 2, 3, 4 or more actors, such as hydraulic cylinders are integrated between two segments. The reliability is increased and the type of the movement of the segment to each other is more finely adjustable.

It is advantageous, if the actor, for example the hydraulic cylinder, is attached with a force transmission to a longitudinal beam of one of the segments and a longitudinal beam or a surface component of another one of the segments. In a corresponding connection, the individual segments can be folded on each other in a space-saving manner. Also, a folding out can then be easily effected.

It is also advantageous, if the longitudinal beams and the diagonal braces define a through tunnel having a preferably triangular cross section. The total weight is then reduced, the access to the fluid or bulk good conduit is ensured and the maintenance is simplified.

For stability it is beneficial if the longitudinal beams and the diagonal braces are constructed/arranged in the manner of a truss or framework.

It is also advantageous, if a longitudinal beam is present on each longitudinal edge of the segments.

An advantageous embodiment is also characterized in that a longitudinal beam determines/fixes/defines at least one of three corners of the segment having a triangular cross section.

If the longitudinal beams and the diagonal braces are connected releasably with each other and/or among themselves, for example by screw connection or riveting, a simple demounting can be therefore carried out. It is also advantageous, if the longitudinal beams and the diagonal braces are connected non-releasably with each other and/or among themselves, for example by laser welding and/or adhering. Theft is then more difficult and undesired demounting is prevented.

In a variant, it has been found to be advantageous, if a clamp or a spider is attached on at least one of the diagonal beams, by which a fixed connection to at least one of the longitudinal beams is achieved. The attachment of the individual components to each other is then efficiently possible.

The stability is increased, if the clamp or the spider is, in each case, connected with one longitudinal beam and multiple diagonal braces, preferably 2, 3, 4, 5, 6, or more diagonal braces.

In particular, it is expedient, if the diagonal braces are effectively arranged as z-shaped reinforcing braces.

In order that the weight is not unnecessarily increased by the clamp or the spider, it is advantageous, if the clamp or the spider is constructed by metal, such as steel for stability reasons or such as a light alloy for lightness reasons, for example aluminum alloy, or by a fiber-reinforced material, for example glass fiber, carbon fibers and/or aramid fibers composite plastic material.

In order that a good connection of the individual parts can be achieved, it is advantageous, if the clamp is attached to the longitudinal beam in the manner of force fit, form fit and/or material fit, preferably friction fit, and/or is attached to one of the diagonal braces in the manner of force fit, form fit and/or material fit, preferably by screw connection or riveting.

Also, it is advantageous, if neither longitudinal beams nor diagonal braces are present at the distal segment. However, in the two or more segments inside the vehicle, such longitudinal beams and diagonal braces are desired.

Also, it is possible that more than only one segment without longitudinal beams and diagonal braces is available, and instead they are placed only on the surface components made of fiber-reinforced plastic material.

If the longitudinal beams are formed as rigid beam elements, the connection is reduced. Also, the bending is reduced. In order that the weight can be kept small, it is advantageous, if the longitudinal beams contain synthetic resin and reinforcing fibers, such as glass fibers, carbon fibers and/or aramid fibers.

Thus, it is an advantage, if the diagonal braces are made of aluminum alloy.

The invention also relates to an agricultural sprayer, such as a land vehicle, for example, a tractor, with an agricultural sprayer arm or two agricultural sprayer arms according to the present invention.

The invention will also be explained as below with the aid of a drawing.

FIG. 1 is a perspective representation of an agricultural sprayer arm constructed from three segments,

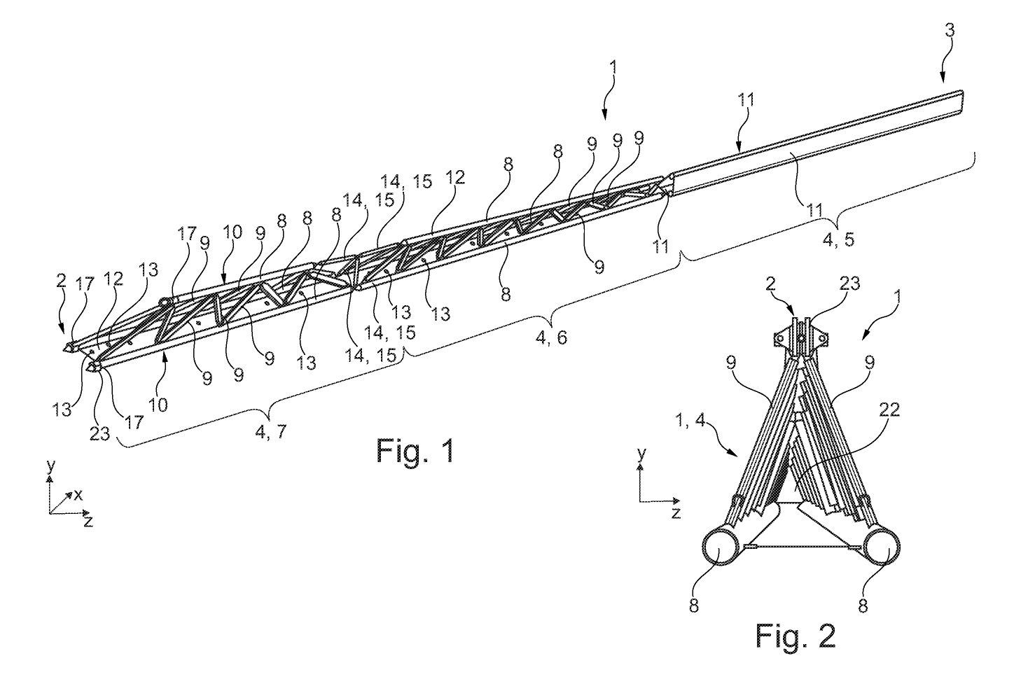

FIG. 2 is a side view of the agricultural sprayer arm along its longitudinal axis,

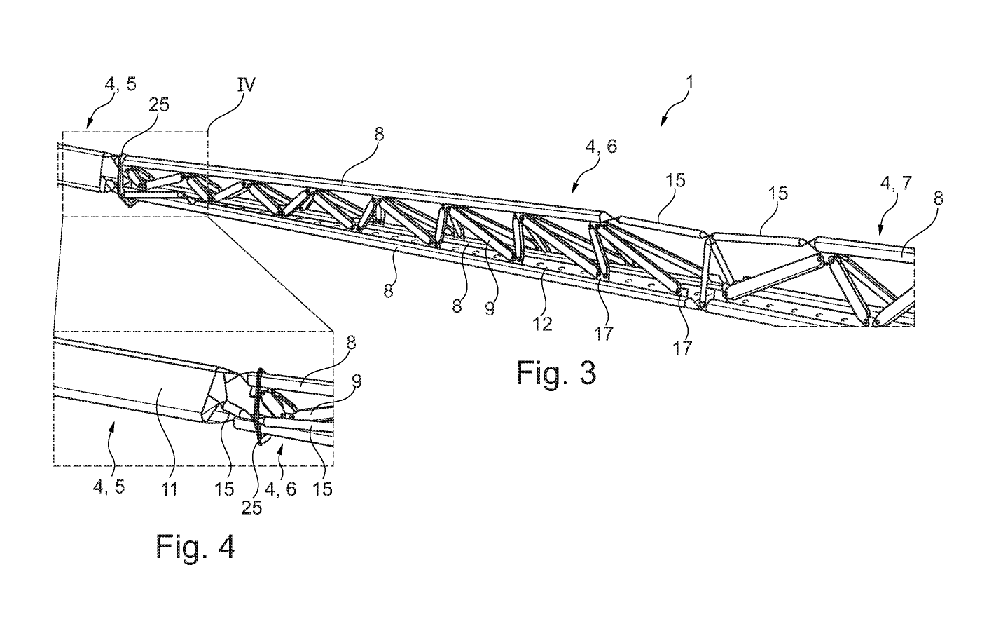

FIG. 3 is a partial sectional perspective view of a middle segment and the adjacent segments which are adjacent thereto and partially illustrated,

FIG. 4 is an enlargement of the area IV of FIG. 3,

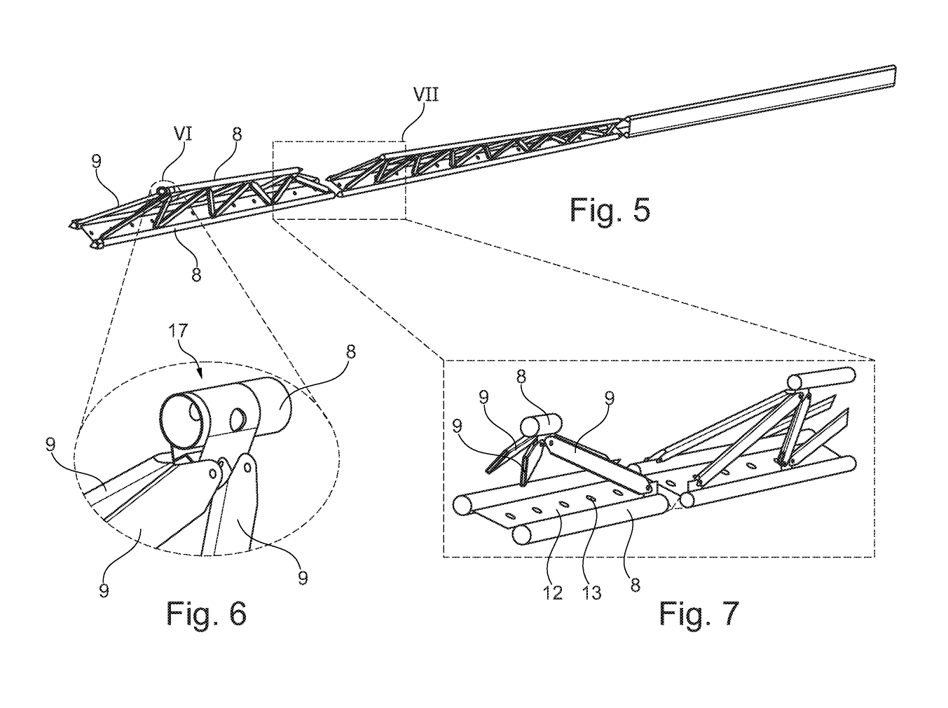

FIG. 5 is a perspective representation which is similar to FIG. 1,

FIG. 6 is an enlargement of the area VI of FIG. 5 with a coupling of the individual components at nodes by means of clamps/spiders instead of mechanical connecting elements,

FIG. 7 is an enlargement of the area VII of FIG. 5 to simplify the hydraulic components at segment transitions by the means of clamps and rigid beam elements in perspective diagram,

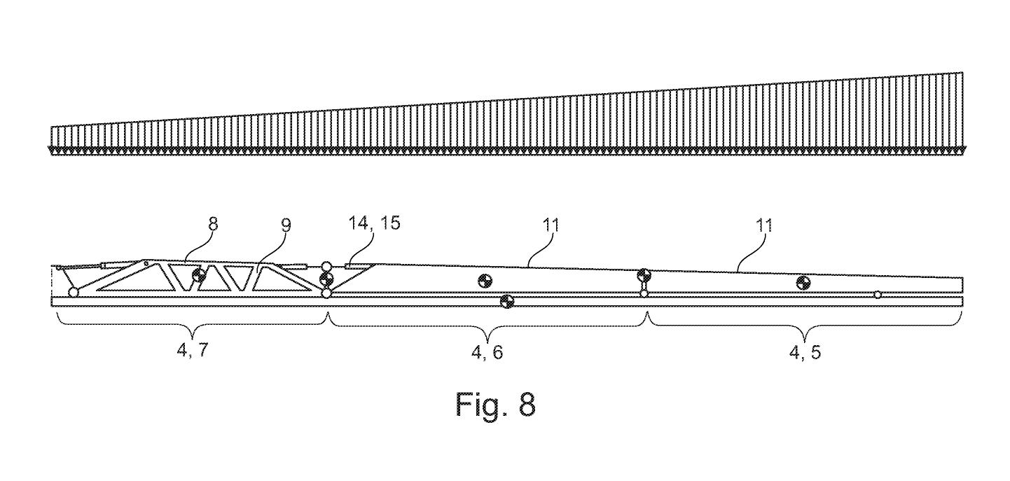

FIG. 8 is a schematic representation of the loads at the agricultural sprayer bar of the agricultural sprayer arm shown along/above the length of the agricultural sprayer arm,

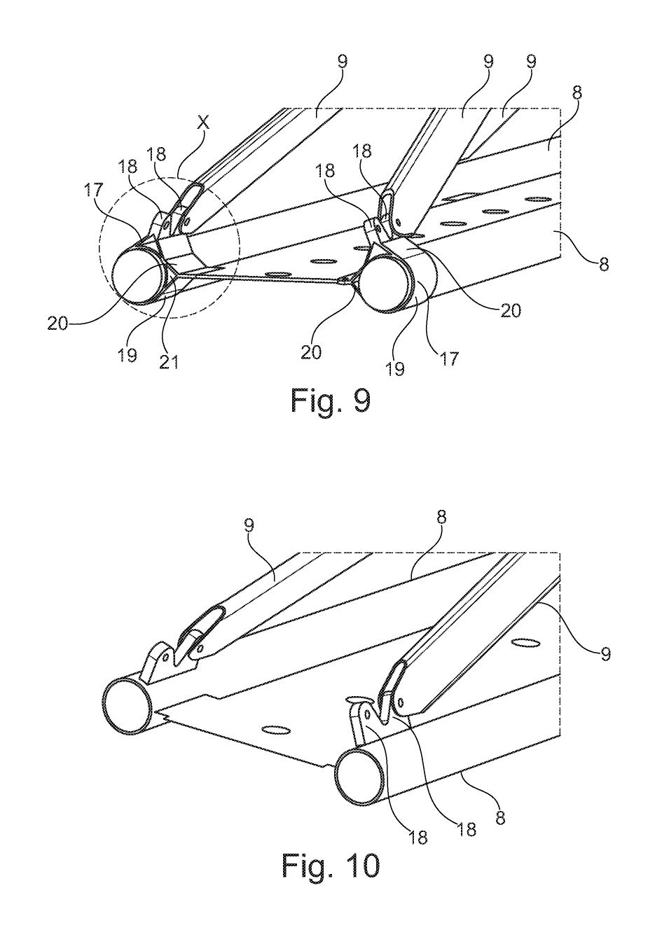

FIG. 9 is a diagram of a coupling area of diagonal braces with longitudinal beams,

FIG. 10 is an alternative configurement of FIG. 9.

The drawings are merely schematic in nature and function to facilitate the understanding of the invention. The same reference signs are used to represent the same elements.

In FIG. 1, a first embodiment of an agricultural sprayer arm 1 according to the present invention is illustrated. The agricultural sprayer arm 1 can also be referred to as an agricultural sprayer bar or is formed at least partially by such a bar. The agricultural sprayer arm 1 is prepared to be attached to a vehicle. The agricultural sprayer arm 1 comprises for this propose a proximal end 2. On the other hand, a distal end 3 remains free. The proximal end 2 is attached, for example, to a tractor or an agricultural sprayer. However, this land vehicle is not illustrated.

The agricultural sprayer arm is provided to receive or fix a conduit, namely a fluid and/or bulk good conduit, which are also not illustrated.

The agricultural sprayer arm 1 comprises in the present embodiment three segments 4. In this case, there is a distal segment 5, a middle segment 6 and a proximal segment 7.

The middle segment 6 and the proximal segment 7 comprise respectively three longitudinal beams 8. The three longitudinal beams 8 of the segment 6 or 7 are connected with each other by multiple diagonal braces 9. For example, the uppermost, vertically highest longitudinal beam 8 is connected with the two vertically lower longitudinal beams 8 by three diagonal braces. However, at a node 10, a vertically lower longitudinal beam 8 is connected with the vertically higher longitudinal beam by only two diagonal braces 9. Ultimately, a truss or framework is formed.

The longitudinal beams 8 are made of fiber-reinforced material, in particular, carbon fiber reinforced plastic, whereas the diagonal braces 9 are made of aluminum.

While the structure of the middle segment 6 and the proximal segment 7 are similar, the structure of the distal segment 5 is completely different, since it is formed without diagonal braces 9, and in a special embodiment formed also without longitudinal beams 8. However, it uses multiple surface components 11, i.e. components that determine a closed surface. In particular, three surface components 11 are used, which are either connected with each other or formed in one piece.

The middle segment 6 and the proximal segment 7 comprise also a panel-type bottom 12, which comprises perforations 13. The perforations 13 are formed as circular holes, in particular through holes. The not illustrated fluid and/or bulk good conduit is thereby attached, such that the good transported by the conduit is spreadable through the perforations due to pressure—and gravity.

A substantially horizontally oriented surface component 11 in the distal segment 5 comprises also perforations 13, so that a spreading of good from the conduit is there also possible.

The longitudinal beams 8 and diagonal braces 9 comprise a uniform thickness. The thickness of the longitudinal beams 8 is equal to or greater by the factor 0.75 or smaller than the wall thickness of the diagonal braces 9.

While the longitudinal beams 8 are mainly under tensile stresses, the diagonal braces 9 are mainly loaded by pressure and/or torsion.

Some hydraulic components 14, such as hydraulic cylinder 15 are present in the area of joints 16, such as swivel joints. At the end of the longitudinal beams 8, clamps or spiders 17 are present, by which the diagonal braces 9 are connected with the longitudinal beams 8.

The clamps 17 therefore partially circularly surround the longitudinal beams 8, and are attached to the diagonal braces 9 with a flat flange portion 18 (better shown in FIGS. 9 and 10). The clamps/spiders 17 are made of metal, for example, of an aluminum alloy. The clamps or spiders 17 comprise outside of a sectionwise circular bushing portion 19 hollow projection extensions 20 with a tapered outer contour. Each projection extension 20 is hollow. A hollow space 21 is therefore present between the peaks of the projection extension 20 and the bushing portion 19.

In FIG. 2, the forming of a through tunnel 22 by the diagonal beams 9 and the longitudinal braces 8 is apparent, as is the presence of a coupling component 23 to attach the proximal end 2 of the proximal segment 4 of the agricultural sprayer arm 1 to the land vehicle.

As shown in FIGS. 3 and 4, a swivel bracket 25 is used. The hydraulic cylinder 15 is thus in operative connection with at least one swivel bracket 25. The longitudinal beams 8 are made of CFRP. The bottom 12 and the connection element formed as clamps/spiders 17 are made of aluminum. Likewise, the diagonal braces 9 can be made of aluminum, but can also be made alternatively or in combination from fiber-reinforced composite material, such as CFRP, or other suitable fiber-containing plastic conglomerates.

The distal segment 5 is completely made of CFRP, and comprises no reinforcing braces.

In the FIGS. 5, 6 and 7, the clamps 17 are illustrated in more detail. The clamps 17 can also be referred to as rigid spider. A simplification of the hydraulic components at a segment transition via such spiders 17 and rigid beam elements is desired. A coupling of the nodes 10 via spiders 17 instead of mechanical connection elements has significant advantages. In the diagrams of FIGS. 5 to 7, the hydraulic components 14 are not apparent, although they are present.

In FIG. 8, the loads at the agricultural sprayer bar is illustrated, wherein the following relationship for the vertical acceleration a, applies:

$${a}_{v} = {a}_{v max} - \frac{x}{{l}_{gesamt}} ( {a}_{v max} - {a}_{v min} )$$

In the example shown here, two outer segments 4 using only surface components 11 are utilized, and only the innermost segment 7 is formed as frame work.

In the FIGS. 9 and 10, the two connection components are shown in more detail in a position of two longitudinal beams 8. A geometry simplification during a component integration is to be noted, which leads to a reduction of the present component mass. Consideration of the different masses of the mass elements for rigid spiders 17 for each connection component was beneficial. In the segment A, a connection segment was achieved with only 275 g, whereas even in a segment B, a lower connection element weighed only 142 g. Connection element and higher beam balanced themselves out.

It has been proven that in the proximal segment, the diagonal braces has a wall thickness that is between 120% and 180% of the (sheet) thickness of the bottom, and the longitudinal beams have a wall thickness that is between 180% and 220%, for example, 200% of the (sheet) thickness of the bottom. Further, it is advantageous, if the bottom in the middle segment has the same thickness as the bottom in the proximal segment. However, the wall thickness of the distal component constructed only by surface components should be 30% greater than the bottom thickness, and/or correspond to the thickness of a diagonal beam, for example, a diagonal beam of the middle segment.

The fiber orientation should be selected corresponding to the traction, pressure and torsion load to be expected.

### Reference Signs List

1 agricultural sprayer arm

2 proximal end

3 distal end

4 segment

5 distal segment

6 middle segment

7 proximal segment

8 longitudinal beam

9 diagonal brace

10 nodes

11 surface component

12 bottom

13 perforation

14 hydraulic component

15 hydraulic cylinder

16 joint

17 clamp/spider

18 flange portion

19 bushing portion

20 projection extension

21 hollow space

22 tunnel

23 coupling component

24 swivel bracket

1. An agricultural sprayer arm to attach a conduit for deployment of some commodities/goods, the agricultural sprayer arm comprising:
multiple foldable segments articulately attached to each other, a shape of at least one segment of which is determined by longitudinal beams mainly underlying tensile stress loaded by traction; and
diagonal braces connected thereto and mainly loaded by pressure and/or torsion,
wherein the longitudinal beams are made of fiber-reinforced material and the diagonal braces are made of a light metal alloy.

2. The agricultural sprayer arm according to claim 1, wherein at least one segment comprises a bottom which is connected with some of the longitudinal beams.

3. The agricultural sprayer arm according to claim 1, wherein the longitudinal beams are hollow.

4. The agricultural sprayer arm according to one of claim 1, wherein the agricultural sprayer arm comprises a distal segment comprising at least fiber-reinforced-material-containing surface component.

5. The agricultural sprayer arm according to claim 4, wherein the distal segment comprises three surface components which are connected with each other in a manner of one piece.

6. The agricultural sprayer arm according to claim 4, wherein a fluid conduit is attached to an inner side or to an outer side of a surface component oriented horizontally in an operation position.

7. The agricultural sprayer arm according to claim 1, wherein every two segments are connected by at least one actor causing a flapping action in an operating mode.

8. The agricultural sprayer arm according to claim 7, wherein the actor is attached with a force transmission to a longitudinal beam of one of the segments and a longitudinal beam or a surface component of another one of the segments.

9. The agricultural sprayer arm according to claim 1, wherein the longitudinal beams and the diagonal braces define a through tunnel.

10. An agricultural sprayer comprising one agricultural sprayer arm or two agricultural sprayer arms according to claim 1.

11. The agricultural sprayer arm according to claim 1, wherein at least one segment comprises a bottom which is connected with some of the diagonal braces.

12. The agricultural sprayer arm according to claim 1, wherein the diagonal braces are hollow.

13. The agricultural sprayer arm according to claim 4, wherein a bulk good conduit is attached to an inner side or to an outer side of a surface component oriented horizontally in an operation position.

14. An agricultural sprayer comprising two agricultural sprayer arms according to claim 1.

15. The agricultural sprayer arm according to claim 4, wherein the distal segment comprises three surface components which are connected with each other by at least one of: form fit, force fit and material fit.
